(19) United States
(12) Patent Application Publication
(10) Pub. No.: US 2006/0247991 A1
(43) Pub. Date: Nov. 2, 2006

(54) System, method, and computer program product for searching credit agencies using partial identification numbers

(75) Inventors: Keye Jin, Montclair, NJ (US); David Patron, New York, NY (US); Vernon Marshall, Montclair, NJ (US); David W. Tolley, New York, NY (US)

Correspondence Address: STERNE, KESSLER, GOLDSTEIN & FOX PLLC, 1100 NEW YORK AVENUE, N.W., WASHINGTON, DC, 20005, US

(73) Assignee: AMERICAN EXPRESS MARKETING & DEVELOPMENT CORP., New York, NY (US)

(21) Appl. No.: 11/236,822

(22) Filed: Sep. 28, 2005

Related U.S. Application Data
(60) Provisional application No. 60/675,846, filed on Apr. 29, 2005.

(51) Int. Cl. G06Q 40/00; G06F 7/00; G06F 17/00

(52) U.S. Cl. 705/35; 707/100

(57) ABSTRACT

A system, method, and computer program product are used to obtain a credit report. The system comprises at least one input device, a credit agency system, and a credit requesting system. The input device receives a partial identification number (e.g., social security number (SSN)) and additional information from an individual. The credit agency system receives the partial SSN and at least a portion of the additional information from the input device and generates a comparison result. The credit requesting system is coupled to the credit agency system and the at least one input device. The credit requesting system controls transmission of the partial SSN and the portion of the additional information to the credit agency system and receives the comparison result from the credit agency system.

### CROSS REFERENCE TO RELATED APPLICATIONS

This application claims benefit under 35 U.S.C. § 119(e) to U.S. Provisional Patent Application 60/675,846, filed Apr. 29, 2005, which is incorporated herein by reference in its entirety.

### BACKGROUND

1. Field of the Invention

The present invention generally relates to obtaining credit reports, and more particularly to using partial personal identification numbers (e.g., social security number) to obtain such credit reports.

2. Related Art

In the United States, for example, three national credit bureaus (Experian of Costa Mesa, Calif.; Trans Union LLC of Chicago, Ill.; and Equifax Inc. of Atlanta, Ga.) serve as clearinghouses for receiving charge and payment transaction information from businesses that grant consumer credit and providing such businesses with consumer credit reports. Businesses voluntarily report customers' charge and payment transactions, typically accompanied by unique identification numbers (i.e., social security numbers) to credit bureaus. Social security numbers are one of the principal personal identification numbers credit bureaus use to update individuals' credit records with the monthly reports of credit and payment activity creditors send them. In addition, credit bureaus use social security numbers provided by customers to retrieve credit reports for such customers' personal information use. Customers are not required to provide social security numbers when requesting reports, but requests without social security numbers need to include enough information to sufficiently identify the individual. Each national credit bureau has more than 180 million credit records. Combined, all three bureaus sell 600 million credit reports annually. Businesses such as insurance companies, collection agencies, and credit granters use social security numbers to request information about customers from credit bureaus.

To determine customers' likelihood of repaying a loan, businesses (e.g., banks and credit card companies in particular) want information on customers' histories of repaying debts and whether customers have filed for bankruptcy or have monetary judgments against them, such as tax liens.

In this age of identity theft and credit fraud, consumers are more protective than ever of their personal information. Given the foregoing, one of the most important pieces of personal information is a social security number, in terms of the amount of damage that can be done to a person's credit. When applying for credit or opening new accounts, consumers are very wary of having to supply and submit any personal information, let alone their social security number. This is even more prevalent when the application for credit or to open an account is done in a public place, such as in a store or other point-of-sale area.

Given the foregoing, what is needed is a system, method and computer program product for reducing the amount of personal information required in a credit or account application.

### BRIEF DESCRIPTION

The present invention meets the above-identified needs by providing a system, method and computer program product for searching credit reports using only a partial identification number (e.g., social security number) and other identifying information.

One embodiment of the present invention provides a method, comprising the following steps. A partial social security number (SSN) of an individual is received. Additional information associated with the individual is received. The partial social security number and at least a portion of the additional information are then used to search a database of a credit agency. A result of the search is determined.

One embodiment of the present invention provides a system comprising at least one input device, a credit agency system, and a credit requesting system. The input device receives a partial SSN and additional information from an individual. The credit agency system receives the partial SSN and at least a portion of the additional information from the input device and generates a comparison result. The credit requesting system is coupled to the credit agency system and the at least one input device. The credit requesting system controls transmission of the partial SSN and the portion of the additional information to the credit agency system and receives the comparison result from the credit agency system.

Further features and advantages of the present invention as well as the structure and operation of various embodiments of the present invention are described in detail below with reference to the accompanying drawings.

### BRIEF DESCRIPTION OF THE DRAWINGS

The features and advantages of the present invention will become more apparent from the detailed description set forth below when taken in conjunction with the drawings. The left-most digit of a reference number identifies the drawing in which the reference number first appears.

FIG. 1 is a system diagram, according to one embodiment of the present invention.

FIGS. 2, 3, and 4 are flowcharts illustrating various processes, according to one or more embodiments of the present invention.

FIG. 5 is a block diagram of a sample computer system that can be used in the implementation of one or more embodiments of the present invention.

### DETAILED DESCRIPTION

I. Overview and Terminology

The present invention is directed to a system, method and computer program product for searching a person's credit at a credit agency using a partial social security number and at least a portion of additionally received information.

The present invention is now described in more detail herein in terms of the above exemplary description. This is for convenience only and is not intended to limit the application of the present invention. In fact, after reading the following description, it will be apparent to one skilled in the relevant art(s) how to implement the following invention in alternative embodiments.

The terms “user,” “end user”, “consumer”, “customer,” “participant,” etc., and/or the plural form of these terms are used interchangeably throughout herein to refer to those persons or entities capable of accessing, using, be affected by and/or benefiting from the tool that the present invention provides for searching credit reports using only a partial social security number and other identifying information.

Furthermore, the terms “business” or “merchant” may be used interchangeably with each other and shall mean any person, entity, distributor system, software and/or hardware that is a provider, broker and/or any other entity in the distribution chain of goods or services. For example, a merchant may be a grocery store, a retail store, a travel agency, a service provider, an on-line merchant or the like.

Transaction Accounts and Instrument

A “transaction account” as used herein refers to an account associated with an open account or a closed account system (as described below), or any other commercial, corporate, or consumer loan or line of credit type of account in which credit-worthiness is a factor in opening and maintaining such accounts. The transaction account may exist in a physical or non-physical embodiment. For example, a transaction account may be distributed in non-physical embodiments such as an account number, frequent-flyer account, and telephone calling account or the like. Furthermore, a physical embodiment of a transaction account may be distributed as a financial instrument.

A financial transaction instrument may be traditional plastic transaction cards, titanium-containing, or other metal-containing, transaction cards, clear and/or translucent transaction cards, foldable or otherwise unconventionally-sized transaction cards, radio-frequency enabled transaction cards, or other types of transaction cards, such as credit, charge, debit, pre-paid or stored-value cards, or any other like financial transaction instrument. A financial transaction instrument may also have electronic functionality provided by a network of electronic circuitry that is printed or otherwise incorporated onto or within the transaction instrument (and typically referred to as a “smart card”), or be a fob having a transponder and an RFID reader.

Open Versus Closed Cards

“Open cards” are financial transaction cards that are generally accepted at different merchants. Examples of open cards include the American Express®, Visa®, MasterCard® and Discover® cards, which may be used at many different retailers and other businesses. In contrast, “closed cards” are financial transaction cards that may be restricted to use in a particular store, a particular chain of stores or a collection of affiliated stores. One example of a closed card is a pre-paid gift card that may only be purchased at, and only be accepted at, a clothing retailer, such as The Gap® store.

Stored Value Cards

Stored value cards are forms of transaction instruments associated with transaction accounts, wherein the stored value cards provide cash equivalent value that may be used within an existing payment/transaction infrastructure. Stored value cards are frequently referred to as gift, pre-paid or cash cards, in that money is deposited in the account associated with the card before use of the card is allowed. For example, if a customer deposits ten dollars of value into the account associated with the stored value card, the card may only be used for payments up to ten dollars.

Use of Transaction Accounts

With regard to use of a transaction account, users may communicate with merchants in person (e.g., at the box office), telephonically, or electronically (e.g., from a user computer via the Internet). During the interaction, the merchant may offer goods and/or services to the user. The merchant may also offer the user the option of paying for the goods and/or services using any number of available transaction accounts. Furthermore, the transaction accounts may be used by the merchant as a form of identification of the user. The merchant may have a computing unit implemented in the form of a computer-server, although other implementations are possible.

In general, transaction accounts may be used for transactions between the user and merchant through any suitable communication means, such as, for example, a telephone network, intranet, the global, public Internet, a point of interaction device (e.g., a point of sale (POS) device, personal digital assistant (PDA), mobile telephone, kiosk, etc.), online communications, off-line communications, wireless communications, and/or the like.

Account and Merchant Numbers

An “account,” “account number” or “account code”, as used herein, may include any device, code, number, letter, symbol, digital certificate, smart chip, digital signal, analog signal, biometric or other identifier/indicia suitably configured to allow a consumer to access, interact with or communicate with a financial transaction system. The account number may optionally be located on or associated with any financial transaction instrument (e.g., rewards, charge, credit, debit, prepaid, telephone, embossed, smart, magnetic stripe, bar code, transponder or radio frequency card).

The account number may be distributed and stored in any form of plastic, electronic, magnetic, radio frequency (RF), wireless, audio and/or optical device capable of transmitting or downloading data from itself to a second device. A customer account number may be, for example, a sixteen-digit credit card number. Each credit card issuer has its own numbering system, such as the fifteen-digit numbering system used by American Express Company of New York, N.Y. Each issuer's credit card numbers comply with that company's standardized format such that an issuer using a sixteen-digit format will generally use four spaced sets of numbers in the form of:
N₁N₂N₃N₄ N₅N₆N₇N₈ N₉N₁₀N₁₁N₁₂ N₁₃N₁₄N₁₅N₁₆

The first five to seven digits are reserved for processing purposes and identify the issuing institution, card type, etc. In this example, the last (sixteenth) digit is typically used as a sum check for the sixteen-digit number.

The intermediary eight-to-ten digits are used to uniquely identify the customer, card holder or cardmember.

A merchant account number may be, for example, any number or alpha-numeric character that identifies a particular merchant for purposes of card acceptance, account reconciliation, reporting and the like.

RFID and Transmission of Magnetic Stripe Data

It should be noted that the transfer of information in accordance with the present invention, may be done in a format recognizable by a merchant system or account issuer. In that regard, by way of example, the information may be transmitted from an RFID device to an RFID reader, or from the RFID reader to the merchant system in magnetic stripe or multi-track magnetic stripe format.

Because of the proliferation of devices using magnetic stripe format, the standards for coding information in magnetic stripe format were standardized by the International Organization for Standardization in ISO/IEC 7811-n (characteristics for identification cards) which are incorporated herein by reference. The ISO/IEC 7811 standards specify the conditions for conformance, physical characteristics for the card (warpage and surface distortions) and the magnetic stripe area (location, height and surface profile, roughness, adhesion, wear and resistance to chemicals), the signal amplitude performance characteristics of the magnetic stripe, the encoding specification including technique (MFM), angle of recording, bit density, flux transition spacing variation and signal amplitude, the data structure including track format, use of error correction techniques, user data capacity for ID-1, ID-2 and ID-3 size cards, and decoding techniques, and the location of encoded tracks.

Typically, magnetic stripe information is formatted in three tracks. Certain industry information must be maintained on certain portion of the tracks, while other portions of the tracks may have open data fields. The contents of each track and the formatting of the information provided to each track is controlled by the ISO/IEC 7811 standard. For example, the information must typically be encoded in binary. Track 1 is usually encoded with user information (i.e., name) in alpha-numeric format. Track 2 is typically comprised of discretionary and nondiscretionary data fields. In one example, the nondiscretionary field may comprise 19 characters and the discretionary field may comprise 13 characters. Track 3 is typically reserved for financial transactions and includes enciphered versions of the user's personal identification number, country code, current units amount authorized per cycle, subsidiary accounts, and restrictions.

As such, where information is provided in accordance with the present invention, it may be provided in magnetic stripe track format. For example, the counter values, authentication tags and encrypted identifiers, described herein, may be forwarded encoded in all or a portion of a data stream representing data encoded in, for example, track 2 or track 3 format.

System Overview

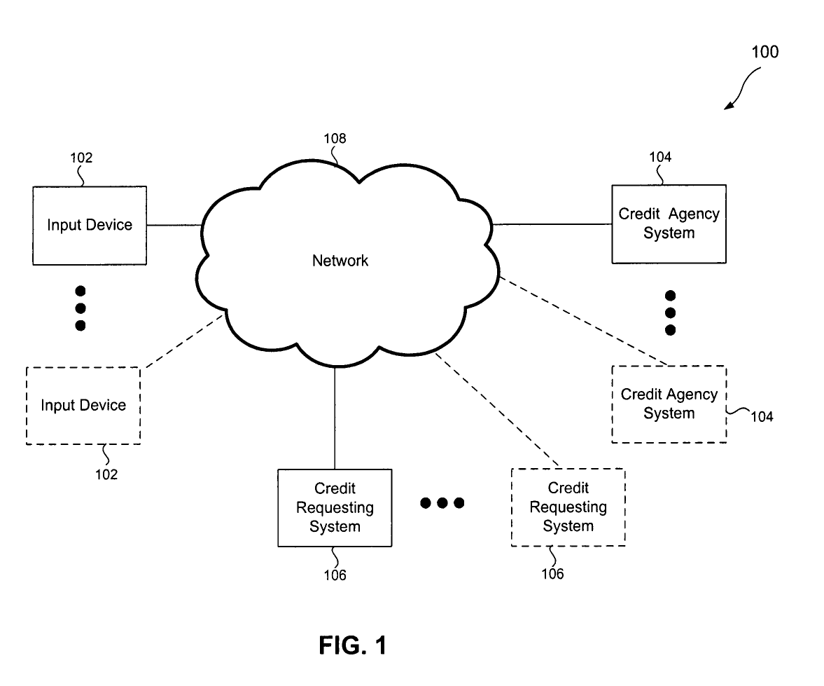

FIG. 1 shows a system 100, according to one embodiment of the present invention. System 100 includes an input device 102, a credit agency system 104, and a credit requesting system 106. In one embodiment, devices 102, 104, and 106 are coupled via a network 108, while in other embodiments they can be directly linked. Network 108 can be a wired or wireless local or distributed system which can utilize (e.g., the Internet, an intranet, or the like).

In one example, input device 102 comprises one or more devices that allow for capturing or receipt of a partial identification number (e.g., social security number) and additional information associated with an individual. For example, input device 102 can be, but is not limited to, a card reader, a keyboard, a touch screen, a kiosk, a voice recognition system, or any other system that allows for this functionality. In one example, input device 102 can be located at a merchant's location, for example, a supermarket, warehouse store, electronics store, point-of-sale terminal, or the like. In various examples, the additional information can be name, address (e.g., street address, Zip code, city, county and/or state), employer, creditor's names, monthly debt payments, or any other information that can be used along with the partial social security number to uniquely identify the individual to credit agency system 104.

In one example, credit agency system 104 can be a system associated with an established credit agency or bureau (e.g., TransUnion, Equifax and Experian), or any credit agency now operating in any jurisdiction or bureau established in the future. System 104 can include various computers, databases, processors, or any other equipment required to receive the partial social security number and at least a portion of the additional information, compare this information with information in one or more databases, and generate a result signal based on the comparison that is transmitted to credit requesting system 106. For example, the comparison result can be a credit report of the individual, a credit score of the individual, or the like.

The databases discussed herein may be any type of database, such as relational, hierarchical, object-oriented, and/or the like. Common database products that may be used to implement the databases include DB2 by IBM (White Plains, N.Y.), any of the database products available from Oracle Corporation (Redwood Shores, Calif.), Microsoft Access or MSSQL by Microsoft Corporation (Redmond, Wash.), or any other database product. Databases may be organized in any suitable manner, including as data tables or lookup tables. Association of certain data may be accomplished through any data association technique known and practiced in the art. For example, the association may be accomplished either manually or automatically. Automatic association techniques may include, for example, a database search, a database merge, GREP, AGREP, SQL, and/or the like. The association step may be accomplished by a database merge function, for example, using a “key field” in each of the manufacturer and retailer data tables. A “key field” partitions the database according to the high-level class of objects defined by the key field. For example, a certain class may be designated as a key field in both the first data table and the second data table, and the two data tables may then be merged on the basis of the class data in the key field. In this embodiment, the data corresponding to the key field in each of the merged data tables is preferably the same. However, data tables having similar, though not identical, data in the key fields may also be merged by using AGREP, for example.

In accordance with one aspect of the present invention, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); block of binary (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In one exemplary embodiment, the ability to store a wide variety of information in different formats is facilitated by storing the information as a Block of Binary (BLOB). Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with the financial transaction instrument by multiple and unrelated owners of the data sets. For example, a first data set which may be stored may be provided by a first issuer, a second data set which may be stored may be provided by an unrelated second issuer, and yet a third data set which may be stored, may be provided by an third issuer unrelated to the first and second issuer. Each of these three exemplary data sets may contain different information that is stored using different data storage formats and/or techniques. Further, each data set may contain subsets of data which also may be distinct from other subsets.

In one example, there may be more than one input device 102, credit request system 106, and credit agency system 104 coupled together either directly or via optional network 108. This can be when several point-of-sale (or point-of-credit application) devices (e.g., input devices 102) send information about several requesting individuals to more than one credit agency system (e.g., credit agency systems 104) from either a same merchant or different merchants, which are all requesting credit from a same credit requesting system 106.

In one example, the personal information and the comparison result can be encrypted or otherwise secured during transmission.

In one example, the partial social security number can be any combination of digits, for example, but not limited to, the first three digits, the middle two digits, the last four digits, the last five digits, or combinations thereof. The digits need not be consecutive (e.g., the first, third, fifth, and last three digits may be used in combination).

Process Overview

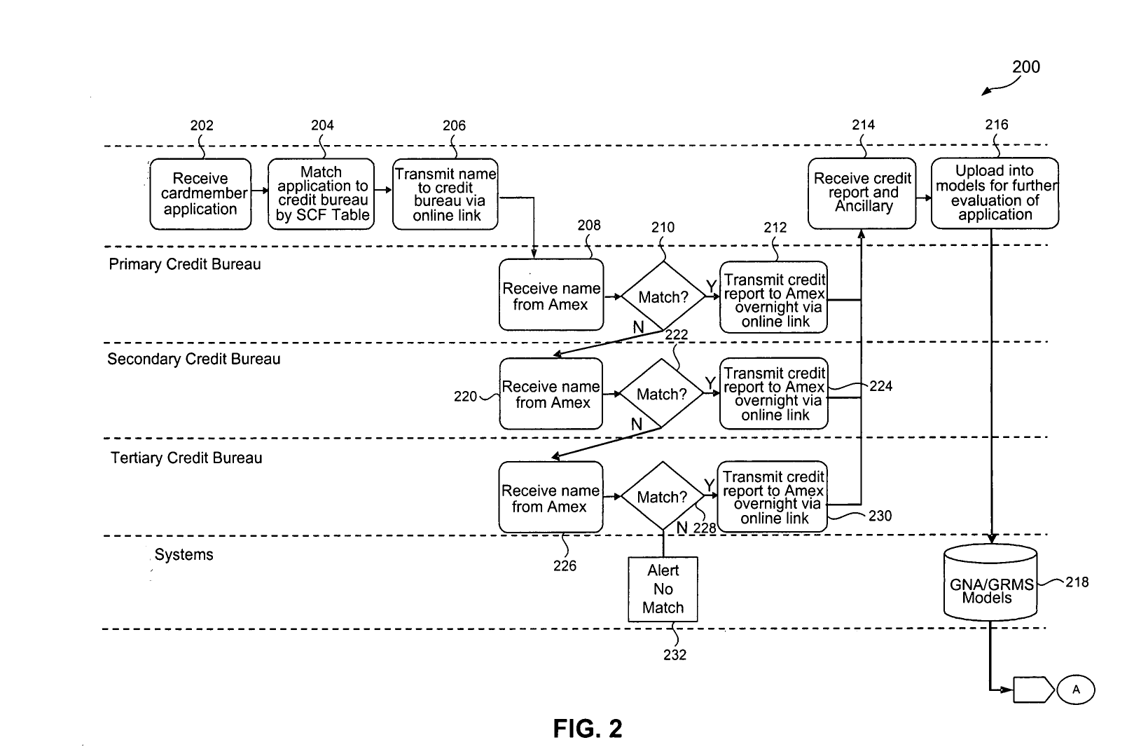

FIG. 2 shows a flowchart illustrating a process 200, according to one embodiment of the present invention. Process 200 begins at step 202, at which a partial social security number and additional information associated with an individual is received (e.g., using an input device 102). In step 204, the partial social security number and at least a portion of the additional information from an application is matched to a credit bureau (e.g., a credit agency system 104) using, in an embodiment, a sectional center facility (SCF) table. An SCF is a U.S. Postal Service center that serves one or more three digit ZIP Code areas. In step 206, the information is transmitted to the credit bureau. In step 208, the information is received at the credit bureau. In step 210, a determination is made whether the partial social security number and the additional information match records stored by the credit bureau. As will be appreciated by those skilled in the relevant art(s), such matching or determination can be made by any of the many well-known techniques of database querying and matching.

If there is a match in step 210, a credit report is transmitted to the requesting system at step 212 and is received at the requesting system at step 214. In step 216, the credit report is used for further evaluation at the requesting system and placed into a database 218 to be used in process 300, described below.

If there is not a match in step 210, the partial social security number and additional information is transmitted to a second credit bureau at step 220. In step 222, a determination is made whether the partial social security number and the additional information match records stored by the second credit bureau.

If there is a match in step 222, a credit report is transmitted to the requesting system at step 224 and is received at the requesting system at step 214. In step 216, the credit report is used for further evaluation at the requesting system and placed into a database 218 to be used in process 300, described below.

If there is not a match in step 222, the information is transmitted to a third credit bureau at step 226. In step 228, a determination is made whether the partial social security number and the additional information match records stored by the third credit bureau.

If there is a match in step 228, a credit report is transmitted to the requesting system at step 230 and is received at the requesting system at step 214. In step 216, the credit report is used for further evaluation at the requesting system and placed into a database 218 to be used in process 300, described below.

If there is not a match in step 228, an alert “no match message” is outputted at step 232 to the requesting system.

In one example, as will be appreciated by those skilled in the relevant art(s) after reading the description herein, while implementing process 200 and the above database examples, the statistical probability that there will be more than one match on a specific additional information (e.g., address, name, Zip code), and the partial social security number received form the customer, is substantially zero.

Step 218 of process 200 is linked to step 302 of process 300 as noted by the “A”.

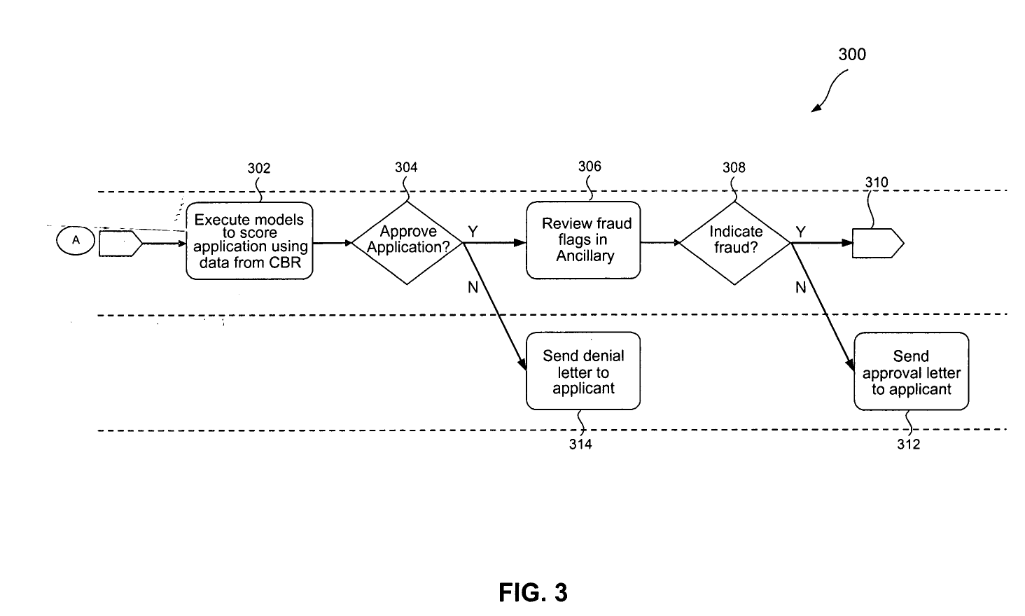

FIG. 3 shows a flow chart illustrating a process 300, according to one embodiment of the present invention. In step 302, models are executed to score the loan, credit, charge or any other transaction account application submitted by the customer to the merchant in step 202 using data from one of the credit reporting bureaus. In step 304, a decision is made whether to approve the application.

If the application is approved in step 304, then fraud flags are received in step 306. In step 308, a decision is made whether there is fraud. If yes, step 310 is performed to alert the requesting system of the fraud. If no, the applicant in step 202 is sent an indicia of approval (e.g., approval letter) (step 312).

If the application is not approved in step 304, then the applicant is sent an indicia of denial (e.g., a denial letter) in step 314.

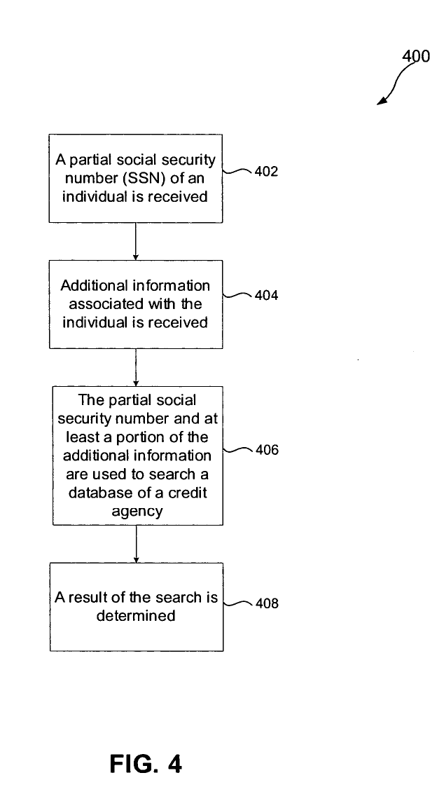

FIG. 4 shows a flow chart illustrating a process 400, according to one embodiment of the present invention. In step 402, a partial social security number (SSN) of an individual is received. In step 404, additional information associated with the individual is received. In step 406, the partial social security number and at least a portion of the additional information are used to search a database of a credit agency. In step 408, a result of the search is determined (i.e., a credit report is obtained), which can then be forwarded to a requesting system.

In the foregoing examples, partial social security numbers are used because social security numbers are a principal identifier used by credit bureaus in the United States. The present invention, however, is not limited to use of partial social security numbers. Other credit reporting systems, such as those in other countries, may use other alpha-numeric or numeric identifiers as a principal identity identifier. As such, the term “identification number” as used herein is intended to include social security numbers and any other unique numeric or alphanumeric identifier system used as a principal identity identifier in a single jurisdiction or across multiple jurisdictions, regardless of whether issued by a government or non-government entity. This may include, for example, any alphanumeric identifier used in the U.S. or any other country as a drivers license number, national ID number, or the like. The term “partial” means any number of digits of the identification number less than the whole.

Example Implementations

The present invention (i.e., system 100, processes 200, 300, and/or 400 or any part(s) or function(s) thereof) may be implemented using hardware, software or a combination thereof and may be implemented in one or more computer systems or other processing systems. However, the manipulations performed by the present invention are often referred to in terms, such as receiving or comparing, which are commonly associated with mental operations performed by a human operator. No such capability of a human operator is necessary, or desirable in most cases, in any of the operations described herein which form part of the present invention. Rather, the operations are machine operations. Useful machines for performing the operation of the present invention include general purpose digital computers or similar devices.

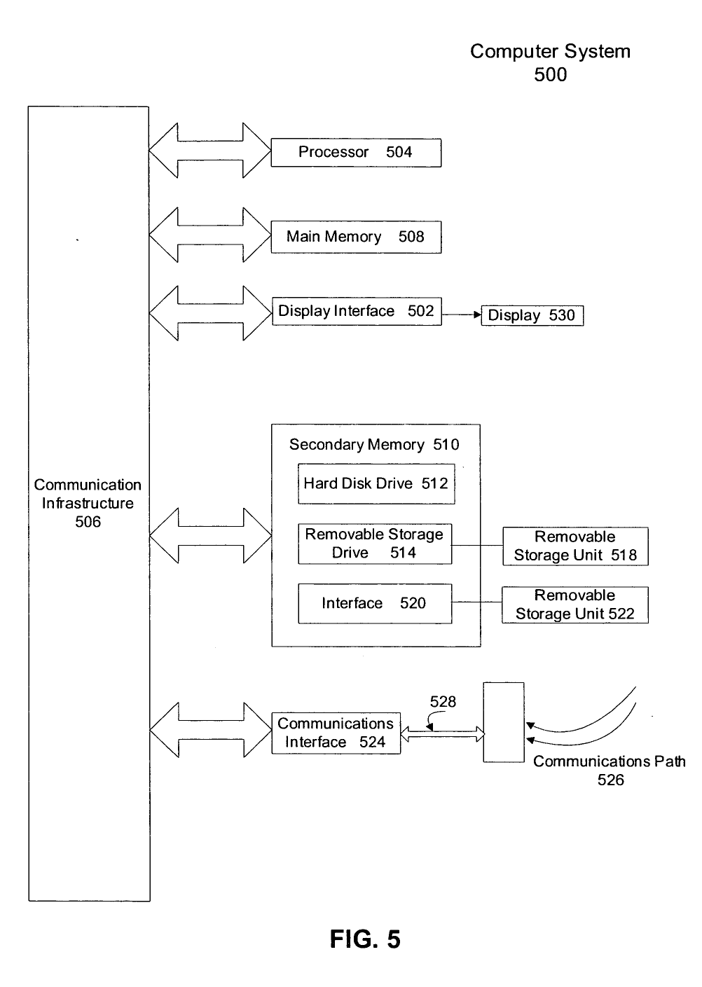

In fact, in one embodiment, the invention is directed toward one or more computer systems capable of carrying out the functionality described herein. An example of a computer system 500 is shown in FIG. 5.

The computer system 500 includes one or more processors, such as processor 504. The processor 504 is connected to a communication infrastructure 506 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 500 can include a display interface 502 that forwards graphics, text, and other data from the communication infrastructure 506 (or from a frame buffer not shown) for display on the display unit 530.

Computer system 500 also includes a main memory 508, preferably random access memory (RAM), and may also include a secondary memory 510. The secondary memory 510 may include, for example, a hard disk drive 512 and/or a removable storage drive 514, representing a floppy disk drive, a magnetic tape drive, an optical disk drive, etc. The removable storage drive 514 reads from and/or writes to a removable storage unit 518 in a well known manner. Removable storage unit 518 represents a floppy disk, magnetic tape, optical disk, etc. which is read by and written to by removable storage drive 514. As will be appreciated, the removable storage unit 518 includes a computer usable storage medium having stored therein computer software and/or data.

In alternative embodiments, secondary memory 510 may include other similar devices for allowing computer programs or other instructions to be loaded into computer system 500. Such devices may include, for example, a removable storage unit 522 and an interface 520. Examples of such may include a program cartridge and cartridge interface (such as that found in video game devices), a removable memory chip (such as an erasable programmable read only memory (EPROM), or programmable read only memory (PROM)) and associated socket, and other removable storage units 522 and interfaces 520, which allow software and data to be transferred from the removable storage unit 522 to computer system 500.

Computer system 500 may also include a communications interface 524. Communications interface 524 allows software and data to be transferred between computer system 500 and external devices. Examples of communications interface 524 may include a modem, a network interface (such as an Ethernet card), a communications port, a Personal Computer Memory Card International Association (PCMCIA) slot and card, etc. Software and data transferred via communications interface 524 are in the form of signals 528 which may be electronic, electromagnetic, optical or other signals capable of being received by communications interface 524. These signals 528 are provided to communications interface 524 via a communications path (e.g., channel) 526. This channel 526 carries signals 528 and may be implemented using wire or cable, fiber optics, a telephone line, a cellular link, a radio frequency (RF) link and other communications channels.

In this document, the terms “computer program medium” and “computer usable medium” are used to generally refer to media such as removable storage drive 514, a hard disk installed in hard disk drive 512, and signals 528. These computer program products provide software to computer system 500. The invention is directed to such computer program products.

Computer programs (also referred to as computer control logic) are stored in main memory 508 and/or secondary memory 510. Computer programs may also be received via communications interface 524. Such computer programs, when executed, enable the computer system 500 to perform the features of the present invention, as discussed herein. In particular, the computer programs, when executed, enable the processor 504 to perform the features of the present invention. Accordingly, such computer programs represent controllers of the computer system 500.

In an embodiment where the invention is implemented using software, the software may be stored in a computer program product and loaded into computer system 500 using removable storage drive 514, hard drive 512 or communications interface 524. The control logic (software), when executed by the processor 504, causes the processor 504 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

### CONCLUSION

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention (e.g., the use of a tax identification number or any other (numeric or alpha-numeric) identifier that uniquely identifies an individual to a credit agency or bureau, as appropriate in the jurisdiction(s) in which the present invention is implemented). Thus, the present invention should not be limited by any of the above described exemplary embodiments, but should be defined only in accordance with the following claims and their equivalents.

In addition, it should be understood that the figures and screen shots illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

Further, the purpose of the following Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application.

The Abstract is not intended to be limiting as to the scope of the present invention in any way.

What is claimed is:

1. A method for obtaining a credit report, comprising:
(a) receiving a partial identification number of an individual;
(b) receiving additional information associated with the individual;
(c) using the partial identification number and at least a portion of the additional information to request a search of a database of a credit agency; and
(d) receiving the credit report based on the search;
whereby a transaction account application may be processed for the individual based on the received credit report without requiring the individual to provide the complete identification number.

2. The method of claim 1, wherein the identification number is a Social Security Number (SSN).

3. The method of claim 2, further comprising:
(e) using the partial SSN and the at least a portion of the additional information to request a search of a database of at least one additional credit agency when the search of the database of the first credit agency does not yield a unique credit report result.

4. The method of claim 2, wherein the additional information comprises at least one of the following pieces of information related to the individual: a name, an address, a Zip code, a previous address, an employer, and a previous employer.

5. The method of claim 2, wherein the complete SSN includes nine digits and step (c) comprises using at least one of the following as the partial SSN: a first three digits, a last four digits, a last five digits, and a middle two digits, of the complete SSN.

6. The method of claim 1, wherein steps (a), (b), (c), and (d) are performed by devices at different physical locations.

7. The method of claim 1, wherein steps (a), (b), and (d) are performed in one of a public place, a store, and a point-of-sale area.

8. A system for obtaining a credit report, comprising:
at least one input device that receives a partial identification number and additional information from an individual;
a credit agency system coupled to the input device, the credit agency system receiving and using the partial identification number and at least a portion of the additional information to conduct a database search; and
a credit requesting system coupled to the credit agency system and the at least one input device, the credit request system controlling transmission of the partial identification number and the at least a portion of the additional information to the credit agency system and receiving the credit report from the credit agency system.

9. The system of claim 8, wherein the identification number is a Social Security Number (SSN).

10. The system of claim 9, further comprising:
a network coupling together the at least one input device, the credit agency system, and the credit requesting system.

11. The system of claim 9, further comprising:
at least one of additional credit agency systems, additional input devices, and additional credit requesting systems.

12. The system of claim 9, wherein the at least one input device comprises at least one of a card reader, a keyboard, a touch screen, a kiosk, a voice recognition device, and a code reading device.

13. The system of claim 9, wherein the at least one input device and the credit requesting system are located in one of a public place, a store, and a point-of-sale area.

14. A computer program product for obtaining a credit report, the computer program product comprising a computer readable medium having control logic stored therein, said control logic comprising:
first computer readable program code means for causing the computer to receive an identification number of an individual;
second computer readable program code means for causing the computer to receive additional information associated with the individual;
third computer readable program code means for causing the computer to use the partial identification number and at least a portion of the additional information to request a search of a database of a credit agency; and
fourth computer readable program code means for receiving the credit report based on the search, whereby a transaction account application may be processed based on the received credit report for the individual without requiring the use of a complete identification number.

15. The computer program product of claim 14, wherein the identification number is a Social Security Number (SSN).

16. The computer program product of claim 15, wherein the complete SSN includes nine digits and said third computer readable program code means comprises computer readable program code means for causing the computer to use at least one of the following as the partial SSN: a first three digits, a last four digits, a last five digits, and a middle two digits, of the complete SSN.

17. Computer program product of claim 15, further comprising:
wherein third computer readable program code means for causing the computer to use the partial identification number and at least a portion of the additional information uses the partial SSN and the at least a portion of the additional information to request a search of a database of at least one additional credit agency when the search of the database of the first credit agency does not yield a unique credit report result.

18. The computer program product of claim 15, wherein the additional information comprises at least one of the following pieces of information related to the individual: a name, an address, a Zip code, a previous address, an employer, and a previous employer.
